(19) United States
(12) Patent Application Publication
(10) Pub. No.: US 2026/0075052 A1
(43) Pub. Date: Mar. 12, 2026

(54) SYSTEMS AND METHODS FOR CONTROLLING SHARED ACCOUNT ACCESS

(71) Applicant: Mastercard International Incorporated, Purchase, NY (US)

(72) Inventors: Sachin Kumar Singh, Pune (IN); Kaushal Shetty, O'Fallon, MO (US); Mayank Joshi, Pune (IN)

(73) Assignee: Mastercard International Incorporated, Purchase, NY (US)

(21) Appl. No.: 18/883,764

(22) Filed: Sep. 12, 2024

(51) Int. Cl. H04L 9/40

(52) U.S. Cl. CPC H04L 63/0861; H04L 63/0823; H04L 63/083; H04L 63/0876

(57) ABSTRACT

A server receives a log in request with credentials. The server compares the credentials to stored account credentials. If matched, the server prompts the user to register a primary device. The server receives a passkey and a HWID associated with the primary device. The server stores these in a database. The server receives a second log in request message from a second device. The server transmits a certificate to the second device. The server receives a second HWID and the certificate, digitally signed using the passkey associated with the primary computing device and transmitted to the secondary device. The server verifies the digital signature and compares the second HWID to the stored HWID. Based on verifying the digital signature and determining that the second HWID does not match, the server prompts the user to register the second device. The server receives a second passkey and stores it in the database.

### BACKGROUND

The present invention relates generally to cryptographic services, and more particularly, to reducing account sharing via shared login credentials by using passkeys.

Account sharing is big concern for many merchants and service providers, such as video or audio streaming platforms. In many instances, users of the service share their login credentials with others who are not part of the service provider's subscription program or who do not purchase the service for themselves. Account sharing allows multiple people to access the service (e.g., streaming platforms) without paying the service provider for their own subscription. While users benefit from cost-saving advantages, the merchants and service providers are negatively impacted because they must provide services to an increasing userbase without realizing an increase in revenue.

### BRIEF DESCRIPTION

This brief description is provided to introduce a selection of concepts in a simplified form that are further described in the detailed description below. This brief description is not intended to identify key features or essential features of the claimed subject matter, nor is it intended to be used to limit the scope of the claimed subject matter. Other aspects and advantages of the present disclosure will be apparent from the following detailed description of the embodiments and the accompanying figures.

In one aspect, a computing system is provided. The computing system includes a database, one or more processors, and computer-executable instructions. The database stores a user account record associated with a user account of a user. The user account record includes stored authentication credentials having a first username and a first password. The computer-executable instructions, when executed by the one or more processors, cause the one or more processors to perform the operations of receiving, from a primary computing device associated with the user, a log in request message to log in to the user account. The log in request message includes received authentication credentials. The received authentication credentials include a second username and a second password. The one or more processors compare the received authentication credentials to the stored authentication credentials and determine that the received authentication credentials match the stored authentication credentials. Based on the match determination, the processors prompt the user to register the primary computing device using a device-supported biometrics verification method of the primary computing device. The processors receive, from the primary computing device, a passkey and a hardware identifier (HWID) associated with the primary computing device and store the passkey and HWID in the database in association with the user account record. The processors receive a second log in request message to log in to the user account from a secondary computing device. In response to the second log in request message, the processors transmit a certificate to the secondary computing device. The processors then receive, from the secondary computing device, a second HWID associated with the secondary computing device and the certificate, digitally signed using the passkey associated with the primary device and transmitted to the secondary computing device. The processors verify a digital signature of the digitally signed certificate utilizing the passkey associated with the account and compare the second HWID to the stored HWID in the database. The processors determine that the second HWID does not match the stored HWID. In response to verifying the digital signature and determining that the second HWID does not match, the processors prompt a second user of the secondary computing device to register the secondary computing device using a device-supported biometrics verification method of the secondary computing device. The processors then receive, from the secondary computing device, a second passkey and the second HWID and store the second passkey and second HWID in the database in association with the user account record.

In another aspect, a method performed by a computing system is provided. The computing system includes a database storing a user account record associated with a user account of a user. The user account record includes stored authentication credentials having a first username and a first password. The method includes receiving, from a primary computing device associated with the user, a log in request message to log in to the user account. The log in request message includes received authentication credentials. The received authentication credentials include a second username and a second password. The method includes comparing the received authentication credentials to the stored authentication credentials and determining that the received authentication credentials match the stored authentication credentials. Furthermore, based on the match determination, the method includes prompting the user to register the primary computing device using a device-supported biometrics verification method of the primary computing device. The method also includes receiving, from the primary computing device, a passkey and a hardware identifier (HWID) associated with the primary computing device. The method includes storing the passkey and HWID in the database in association with the user account record. Moreover, the method includes receiving a second log in request message to log in to the user account from a secondary computing device. In response to the second log in request message, the method includes transmitting a certificate to the secondary computing device and receiving, from the secondary computing device, a second HWID associated with the secondary computing device and the certificate, digitally signed using the passkey associated with the primary device and transmitted to the secondary computing device. Additionally, the method includes verifying a digital signature of the digitally signed certificate utilizing the passkey associated with the account and comparing the second HWID to the stored HWID in the database. The method includes determining that the second HWID does not match the stored HWID. In response to verifying the digital signature and determining that the second HWID does not match, the method includes prompting a second user of the secondary computing device to register the secondary computing device using a device-supported biometrics verification method of the secondary computing device. Furthermore, the method includes receiving, from the secondary computing device, a second passkey and the second HWID, and storing the second passkey and second HWID in the database in association with the user account record.

In yet another aspect, a non-transitory computer-readable storage medium is provided. The computer-readable storage medium has computer-executable instructions stored thereon. The computer-executable instructions, when executed by one or more processors, cause the one or more processors to perform operations of receiving, from a primary computing device associated with a user, a log in request message to log in to a user account. The log in request message includes received authentication credentials. The received authentication credentials include a first username and a first password. The computer-executable instructions cause the processors to compare the received authentication credentials to stored authentication credentials stored in a database. The database stores a user account record associated with the user account of the user. The user account record includes the stored authentication credentials having a second username and a second password. The computer-executable instructions also cause the processors to determine that the received authentication credentials match the stored authentication credentials. Based on the match determination, the computer-executable instructions cause the processors to prompt the user to register the primary computing device using a device-supported biometrics verification method of the primary computing device. Furthermore, the computer-executable instructions cause the processors to receive, from the primary computing device, a passkey and a hardware identifier (HWID) associated with the primary computing device and to store the passkey and HWID in the database in association with the user account record. Moreover, the computer-executable instructions cause the processors to receive a second log in request message to log in to the user account from a secondary computing device. In response to the second log in request message, the computer-executable instructions cause the processors to transmit a certificate to the secondary computing device. The processors receive, from the secondary computing device, a second HWID associated with the secondary computing device and the certificate, digitally signed using the passkey associated with the primary device and transmitted to the secondary computing device. Furthermore, the computer-executable instructions cause the processors to verify a digital signature of the digitally signed certificate utilizing the passkey associated with the account and compare the second HWID to the stored HWID in the database. Additionally, the computer-executable instructions cause the processors to determine that the second HWID does not match the stored HWID. In response to verifying the digital signature and determining that the second HWID does not match, the computer-executable instructions cause the processors to prompt a second user of the secondary computing device to register the secondary computing device using a device-supported biometrics verification method of the secondary computing device. Furthermore, the computer-executable instructions cause the processors to receive, from the secondary computing device, a second passkey and the second HWID, and to store the second passkey and second HWID in the database in association with the user account record.

A variety of additional aspects will be set forth in the detailed description that follows. These aspects can relate to individual features and to combinations of features. Advantages of these and other aspects will become more apparent to those skilled in the art from the following description of the exemplary embodiments which have been shown and described by way of illustration. As will be realized, the present aspects described herein may be capable of other and different aspects, and their details are capable of modification in various respects. Accordingly, the figures and description are to be regarded as illustrative in nature and not as restrictive.

### BRIEF DESCRIPTION OF THE DRAWINGS

The figures described below depict various aspects of systems and methods disclosed therein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 is an exemplary system for reducing account sharing using shared login credentials, in accordance with embodiments of the present disclosure;

FIG. 2 is an example configuration of a user computing device for use with the system of FIG. 1;

FIG. 3 is an example configuration of a server system, such as the server system shown in FIG. 1; and

FIGS. 4A, 4B, and 4C depict a flowchart illustrating an exemplary computer-implemented method for reducing account sharing via shared login credentials, in accordance with embodiments of the present disclosure.

Unless otherwise indicated, the figures provided herein are meant to illustrate features of embodiments of this disclosure. These features are believed to be applicable in a wide variety of systems comprising one or more embodiments of this disclosure. As such, the figures are not meant to include all conventional features known by those of ordinary skill in the art to be required for the practice of the embodiments disclosed herein.

### DETAILED DESCRIPTION

The following detailed description of embodiments of the invention references the accompanying figures. The embodiments are intended to describe aspects of the invention in sufficient detail to enable those with ordinary skill in the art to practice the invention. The embodiments of the invention are illustrated by way of example and not by way of limitation. Other embodiments may be utilized, and changes may be made without departing from the scope of the claims. The following description is, therefore, not limiting. The scope of the present invention is defined only by the appended claims, along with the full scope of equivalents to which such claims are entitled.

### Exemplary System

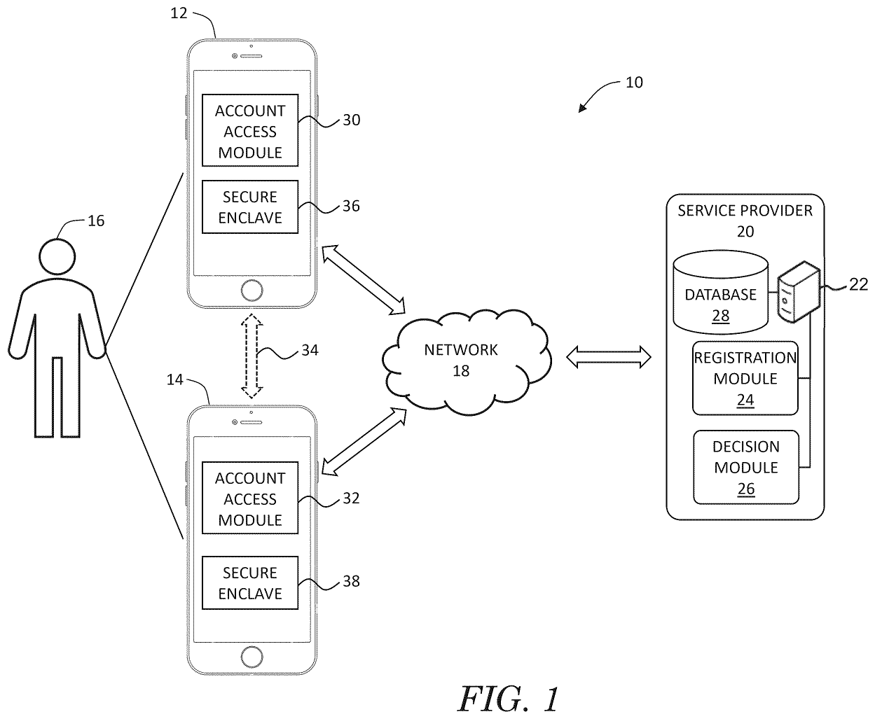

FIG. 1 depicts an exemplary system 10 for reducing account sharing using shared login credentials (e.g., userID and password), in accordance with embodiments of the present disclosure. The system 10 advantageously limits access to an account to only registered computing devices. After a primary computing device 12 is registered to the account, the use of traditional login credentials may be restricted. Secondary computing devices, such as a secondary computing device 14, may be granted access to the account via the primary device 12, for example, by receiving an access token from the primary device 12. The secondary computing device 14 may then be registered to the account.

In the example embodiment, the system 10 may broadly include the primary user computing device 12, the secondary user computing device 14, and a service provider 20, all interconnected via a communication network 18. The primary user computing device 12 may further include an account access module 30. In addition, the secondary user computing device 14 may further include an account access module 32. The service provider 20 may include a server computing device 22 and a database 28. The server computing device 22 may include a registration module 24 and an authentication decision module 26. In an embodiment, the function of the system 10 may be reflected in the operations of the method 400 described below and may include any additional features described in association with the method 400.

With respect to the user computing devices 12, 14, the account access modules 30, 32 may be configured to facilitate one or more users, such as a user 16, logging into an account provided by the service provider 20. The communication network 18 generally allows communication between the account access modules 30, 32 and the registration module 24. For example, the communication network 18 may provide wired and/or wireless communication between the account access modules 30, 32 and the registration module 24. Each of the account access modules 30, 32 and the registration module 24 may be configured to transmit data to and/or receive data from the communication network 18 using one or more suitable communication protocols, which may be the same communication protocols or different communication protocols as one another. For example, the account access modules 30, 32 may periodically request various services from the registration module 24 over the communication network 18.

The communication network 18 may include one or more telecommunication networks, nodes, and/or links used to facilitate data exchanges between one or more devices and may facilitate a connection to the Internet for devices configured to communicate with communication network 18. The communication network 18 may include local area networks, metro area networks, wide area networks, cloud networks, the Internet, cellular networks, plain old telephone service (POTS) networks, and the like, or combinations thereof. The communication network 18 may be wired, wireless, or combinations thereof and may include components such as modems, gateways, switches, routers, hubs, access points, repeaters, towers, and the like.

The account access modules 30, 32 and the registration module 24 may connect to the communication network 18 either through wires, such as electrical cables or fiber optic cables, or wirelessly, such as radio frequency (RF) communication using wireless standards such as cellular 3G, 4G, 5G, and the like, Institute of Electrical and Electronics Engineers (IEEE) 802.11 standards such as Wi-Fi, IEEE 802.16 standards such as WiMAX, Bluetooth™, or combinations thereof. In aspects in which the communication network 18 facilitates a connection to the Internet, data communications may take place over the communication network 18 via one or more suitable Internet communication protocols. For example, the communication network 18 may be implemented as a wireless telephony network (e.g., GSM, CDMA, LTE, etc.), a Wi-Fi network (e.g., via one or more IEEE 802.11 Standards), a WiMAX network, a Bluetooth network, etc.

The registration module 24 may be configured to transmit a message to the account access modules 30, 32 prompting the user 16 to register the user computing devices 12, 14, respectively, with the server provider 20 (via the registration module 24). In an embodiment, the registration module 24 prompts the user 16 to register the primary and/or secondary user computing devices 12, 14 using a device-supported biometrics verification method for a passwordless authentication experience for subsequent access to the account on the server computing device 22.

A device-supported biometrics verification method may include, for example, one or more scans or digital representations of select physical features of the user 16 that are to be validated by the user computing devices 12 and/or 14, for example, during device registration and/or account access. The biometrics or physical features of the user 16 may include, for example, voice recognition, fingerprints, iris features, vein patterns, facial features, or the like. In an embodiment, the device-supported biometrics verification method may include a direct personal identification number (PIN) entry to the device.

The registration module 24 may be further configured to facilitate registration of the user computing devices 12, 14, including receiving and storing a device identifier (ID) (or device fingerprint) and a passwordless Fast Identity Online (FIDO) credential (also referred to herein as a passkey). The device ID and passkey may be stored in an account record on the database 28. A passkey (i.e., FIDO credential) may be created and shared from the user computing devices 12 and 14 using a process called FIDO authentication, which relies on public key cryptography. During the registration process, the user computing device 12 or 14, respectively, may generate a new pair of cryptographic keys: a private key and a public key (the two parts of the passkey), via a secure enclave, such as a secure enclave 36 or 38, respectively, of the device. A secure enclave may include a dedicated secure subsystem of the device. The private key may be stored securely on the respective user computing device 12 or 14, for example, in the secure enclave 36 or 38, respectively, of the device. The public key may be shared with the registration module 24. The public key generated and shared by the respective user computing device 12 or 14 may be securely bound to the user's account with the service provider 20. For example, the shared public key may be securely bound to the account login credentials (e.g., the userID and password) and the device ID of the generating user computing device 12 or 14. Such binding ensures that only the registered user computing device 12 or 14 may use the corresponding private key to authenticate with the service provider.

The device ID or fingerprint may include, for example, a hardware identifier (HWID). HWIDs include unique identifiers that identify each piece of hardware on a computing device. A HWID may include a unique set of numbers and letters that may function as a device fingerprint for each hardware component. Example HWIDs may include, without limitation, a Media Access Control (MAC) address, International Mobile Equipment Identity (IMEI) number, International Mobile Subscription Identifier (IMSI), Electronic Serial Number (ESN), Mobile Equipment Identifier (MEID), and the like.

The authentication decision module 26 may be configured to receive device IDs or device fingerprints (e.g., the HWIDs), account credentials, and/or passkeys from computing devices, such as the user computing device 12 or 14. In an embodiment, the authentication decision module 26 may identify the user computing device 12 or 14 via the HWID, receive a passkey therefrom, and verify the passkey against the registered account record stored on the database 28.

When the user 16 attempts to access his or her account with the service provider 20 using, for example, the user computing device 12 or 14, the respective account access modules 30, 32 may establish communication with the authentication decision module 26 of the server computing device 22. The authentication decision module 26 may prompt the user 16, via the account access module 30 or 32, for account access credentials and/or a passkey. The user 16 may submit the account access credentials and/or passkey to the authentication decision module 26, for example, via the account access module 30 or 32. Optionally, the access credentials and/or passkey may automatically be transmitted to the authentication decision module 26.

The authentication decision module 26 may compare the access credentials and/or passkey to the account records stored on the database 28 and make an identity authentication determination based thereon. The authentication decision module 26 may authenticate the device based on a match. Alternatively, if there is no match of the access credentials and/or passkey, the authentication decision module 26 may not authenticate the device and may deny further access to the server computing device 22 and/or terminate the communication link between the server computing device 22 and user computing device 12 or 14.

### Exemplary Computer Systems

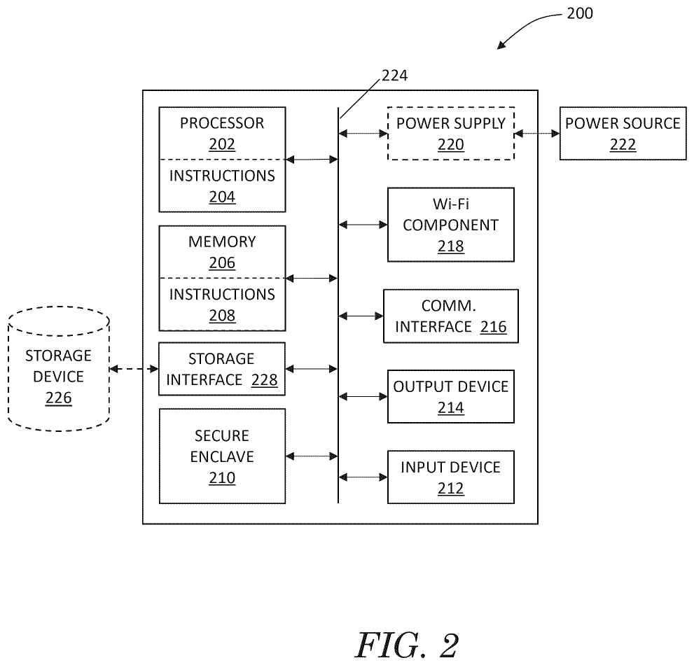

FIG. 2 is an example configuration of a user computing device 200, such as the user computing devices 12, 14 (shown in FIG. 1). In the exemplary embodiment, the user computing device 200 may be a computing device configured to connect to the server computing device 22 (shown in FIG. 1) or any other computing devices, for example, via the communication network 18.

In the exemplary embodiment, the user computing device 200 may generally include one or more processors 202, a memory device 206, a secure enclave 210, an input device 212, an output device 214, a communication interface 216, an integrated Wi-Fi component 218 (e.g., implementing the Institute of Electrical and Electronics/IEEE 802.11 family of standards), each of which may communicate with each other component over an interconnect 224 (e.g., a bus). Optionally, the user computing device 200 may include an internal power supply 220 (e.g., a battery or other self-contained power source) to receive power. Alternatively, in some embodiments, the user computing device 200 may include an external power source 222.

The one or more processors 202 may include one or more processing units (e.g., in a multi-core configuration) specially programmed for executing computer readable instructions, such as instruction 204. The instructions 204 may be executed within a variety of different operating systems (OS) on the user computing device 200, such as UNIX, LINUX, Microsoft Windows®, etc. More specifically, the instructions may cause various data manipulations on data stored in the memory device 206 (e.g., create, read, write, update, and delete procedures). It should also be appreciated that upon initiation of a computer-based method, various instructions 204 may be executed during initialization. Some operations may be required to perform one or more processes described herein, while other operations may be more general and/or specific to a programming language (e.g., C, C #, C++, Java, or other suitable programming languages, etc.). The memory device 206 may be any device allowing information such as cryptographic keys, executable instructions 208, and/or other data to be stored and retrieved. The memory device 206 may include one or more computer readable media.

In the example embodiment, the processor 202 may be implemented as one or more cryptographic processors. A cryptographic processor may include, for example, dedicated circuitry and hardware such as one or more cryptographic arithmetic logic units (not shown) that are optimized to perform computationally intensive cryptographic functions. A cryptographic processor may be a dedicated microprocessor for carrying out cryptographic functions, embedded in a packaging with multiple physical security measures, which facilitate providing a degree of tamper resistance. A cryptographic processor facilitates providing a tamper-proof boot and/or operating environment, and persistent and volatile storage encryption to facilitate secure, encrypted transactions.

Because the user computing device 200 may be widely deployed, it may be impractical to manually update software for each user computing device 200. Therefore, the system 10 may provide a mechanism for automatically updating the software on the user computing device 200. For example, an updating mechanism may be used to automatically update any number of components and their drivers, both network and non-network components, including system level (OS) software components. In some embodiments, the user computing device 200 components may be dynamically loadable and unloadable; thus, they may be replaced in operation without having to reboot the OS.

The memory device 206 may be any type of memory device that enables the user computing device 200 to function as described herein. For example, the memory device 206 may be random access memory (RAM) in accordance with a Joint Electron Devices Engineering Council (JEDEC) design such as the DDR or mobile DDR standards (e.g., LPDDR, LPDDR2, LPDDR3, or LPDDR4). In some embodiments, the memory device 206 may include two or more memory devices and may be of any number of different package types such as single die package (SDP), dual die package (DDP) or quad die package (Q17P). The memory device 206, in some examples, may be directly soldered onto a motherboard (not shown) and/or may be configured as one or more memory modules that couple to the motherboard via a connector. Any number of other memory implementations may be used, such as other types of memory modules, including, but not limited to, read-only memory (ROM), erasable programmable read-only memory (EPROM), electrically erasable programmable read-only memory (EEPROM), and non-volatile RAM (NVRAM). The above memory types are exemplary only and are thus not limiting as to the types of memory usable for storage of a computer program.

The secure enclave 210 is configured to separate and protect sensitive code and data from other processes running on the user computing device 200. In the example embodiment, the secure enclave 210 operates as a trusted execution environment (TEE). The TEE is a secure area of a main processor, such as the one or more processors 202, which guarantees confidentiality and integrity of code and data loaded inside. The TEE, as an isolated execution environment, provides security features such as isolated execution, integrity of applications executing with the TEE, along with confidentiality of their assets. The TEE (or secure enclave 210) may be a hardware, software, or firmware component (e.g., Trusted Computing Group (TCG) Trusted Platform Module (TPM), Trusted Execution Environment (TEE), Virtual TPM, Intel® Software Guard Extension (SGX), Intel® Enhanced Privacy ID (EPID), Arm TrustZone, SIM card based on Java Card technology, etc.). The secure enclave 210 may provide a set of trusted functions that execute in the TEE on the user computing device 200. The trusted functions may include, for example, device identification, key generation, encrypt, decrypt, sign and verify operations, etc.

The secure enclave 210 may ensure that sensitive data is stored, processed, and protected in a trusted environment. In some embodiments, the secure enclave 210 may be tamper-proof. For example, the secure enclave 210 may include tampering evidence capability (for tamper-proofing), which is a desired security function for storing encryptions keys, authentication credentials, and/or payment credentials. The ability of the secure enclave 210 to offer safe execution of cryptographic functions for authorized security software, which are sometimes referred to as “trusted applications,” enables the secure enclave 210 to provide end-to-end security by enforcing protection, confidentiality, integrity, and data access rights.

Stored in the memory device 206 are, for example, computer readable instructions 208 for providing a user interface to a user via the output device 214 and, optionally, receiving and processing input from the input device 212. A user interface may include, among other possibilities, a web browser and a business application. Web browsers enable users to view and interact with media and other information typically embedded on a web page or a website. A client or business application allows the user to interact with a server application, for example, associated with the server computing device 22.

The input device 212 may include, for example, a touch sensitive panel, a touch pad, a touch screen, a stylus, a gyroscope, an accelerometer, a position detector, a keyboard, a pointing device, a mouse, or an audio input device. A single component such as a touch screen may function as both the output device 214 and the input device 212. The user computing device 200 may also include a communication interface 216, which is communicatively connectable to a remote device such as the server computing device 22. The communication interface 216 may provide, for example, a wired communication to the communication network 18 or to other devices, such as the server computing device 22. The wired communication may provide an Ethernet connection or may be based on other types of networks, such as Controller Area Network (CAN), Local Interconnect Network (LIN), DeviceNet, ControlNet, etc.

In the example embodiment, the output device 214 may include, for example, and without limitation, a liquid crystal display (LCD), an organic light emitting diode (OLED) display, or an “electronic ink” display. In some embodiments, a single component such as a touch screen may function as both an output device (e.g., the output device 214) and the input device 212. As such, the output device 214 may optionally include a touch controller for support of touch capability. In such embodiments, the user computing device 200 may detect a user's presence by detecting that the user has touched the output device 214 of the user computing device 200.

The Wi-Fi component 218 (broadly, a communication interface) may be communicatively connectable to a remote device such as the network 18 (shown in FIG. 1), the server computing device 22 (shown in FIG. 1), and/or the server system 40 (shown in FIG. 2). The Wi-Fi component 218 may include, for example, a wireless or wired network adapter or a wireless data transceiver for use with Wi-Fi (e.g., implementing the Institute of Electrical and Electronics/IEEE 802.11 family of standards), Bluetooth communication, radio frequency (RF) communication, near field communication (NFC), and/or with a mobile phone network, Global System for Mobile communications (GSM), 3G, or other mobile data network, and/or Worldwide Interoperability for Microwave Access (WiMax) and the like.

The processor 202 may be operatively coupled to a storage device 226. The storage device 226 may be any computer-operated hardware suitable for storing and/or retrieving data, such as data encryption keys described herein. In some embodiments, the storage device 226 may be integrated into the user computing device 200. In other embodiments, the storage device 226 may be external to the user computing device 200 and is similar to the database 28 (shown in FIG. 1). For example, the user computing device 200 may include one or more hard disk drives that function as the storage device 226. In other embodiments, where the storage device 226 may be external to the user computing device 200, the storage device 226 may be accessed by a plurality of server systems 200. For example, the storage device 226 may include multiple storage units such as hard disks or solid-state disks in a redundant array of inexpensive disks (RAID) configuration. The storage device 226 may include a storage area network (SAN) and/or a network attached storage (NAS) system.

In some embodiments, the processor 202 may be operatively coupled to the storage device 226 via a storage interface 228. The storage interface 228 may be any component capable of providing the processor 202 with access to the storage device 226. The storage interface 228 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 202 with access to the storage device 226.

In some embodiments, the user computing device 200 may be connected to one or more peripheral devices (not shown). That is, the user computing device 200 may communicate various data with one or more peripheral devices. For example, the user computing device 200 may communicate with one or more peripheral devices through the Wi-Fi component 218, the communication interface 216, or other suitable means.

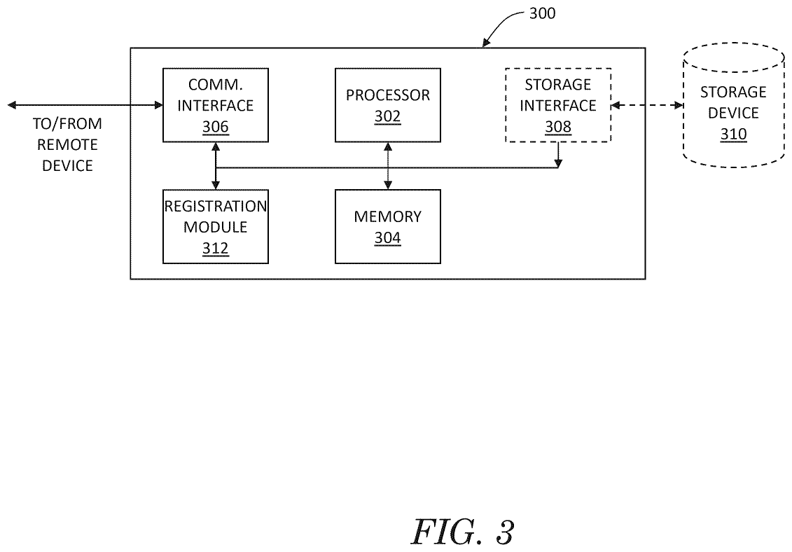

FIG. 3 is an example configuration of a server system 300. In an embodiment, the server system 300 may include, but not be limited to, the server computing device 22 (shown in FIG. 1). In the example embodiment, the computing system 300 may include a processor 302 for executing instructions. The instructions may be stored in a memory 304, for example. The processor 302 may include one or more processing units (e.g., in a multi-core configuration) for executing the instructions. The instructions may be executed within a variety of different operating systems on the computing system 300, such as UNIX, LINUX, Microsoft Windows®, etc. More specifically, the instructions may cause various data manipulations on data stored in a storage device 310 (e.g., create, read, update, and delete procedures). It should also be appreciated that upon initiation of a computer-based method, various instructions may be executed during initialization. Some operations may be required to perform one or more processes described herein, while other operations may be more general and/or specific to a programming language (e.g., C, C #, C++, Java, or other suitable programming languages, etc.).

The processor 302 may be operatively coupled to a communication interface 306 such that the computing system 300 can communicate with a remote device such as a user computing system 200 (shown in FIG. 2), one or more of the user computing devices 12, 14, and/or another server computing system. For example, the communication interface 306 may receive communications from a user computing device 12 or 14 via the Internet.

The processor 302 may be operatively coupled to the storage device 310. The storage device 310 may be any computer-operated hardware suitable for storing and/or retrieving data. In some embodiments, the storage device 310 may be integrated in the computing system 300. In other embodiments, the storage device 310 may be external to the computing system 300. The storage device may be similar to the database 28 (shown in FIG. 1). For example, the computing system 300 may include one or more hard disk drives as the storage device 310. In other embodiments, the storage device 310 may be external to the computing system 300 and may be accessed by a plurality of server systems 300. For example, the storage device 310 may include multiple storage units such as hard disks or solid-state disks in a redundant array of inexpensive disks (RAID) configuration. The storage device 310 may include a storage area network (SAN) and/or a network attached storage (NAS) system.

In some embodiments, the processor 302 may be operatively coupled to the storage device 310 via a storage interface 308. The storage interface 308 may be any component capable of providing the processor 302 with access to the storage device 310. The storage interface 308 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 302 with access to the storage device 310.

The memory 304 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only and are thus not limiting as to the types of memory usable for storage of a computer program.

### Computer-Implemented Methods

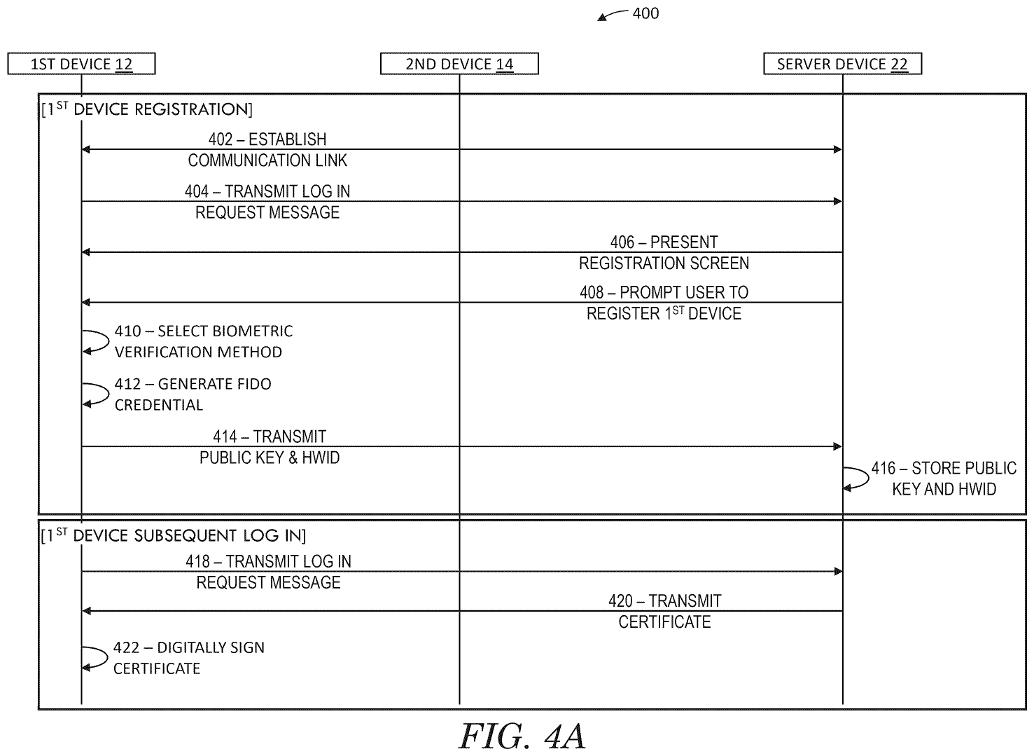

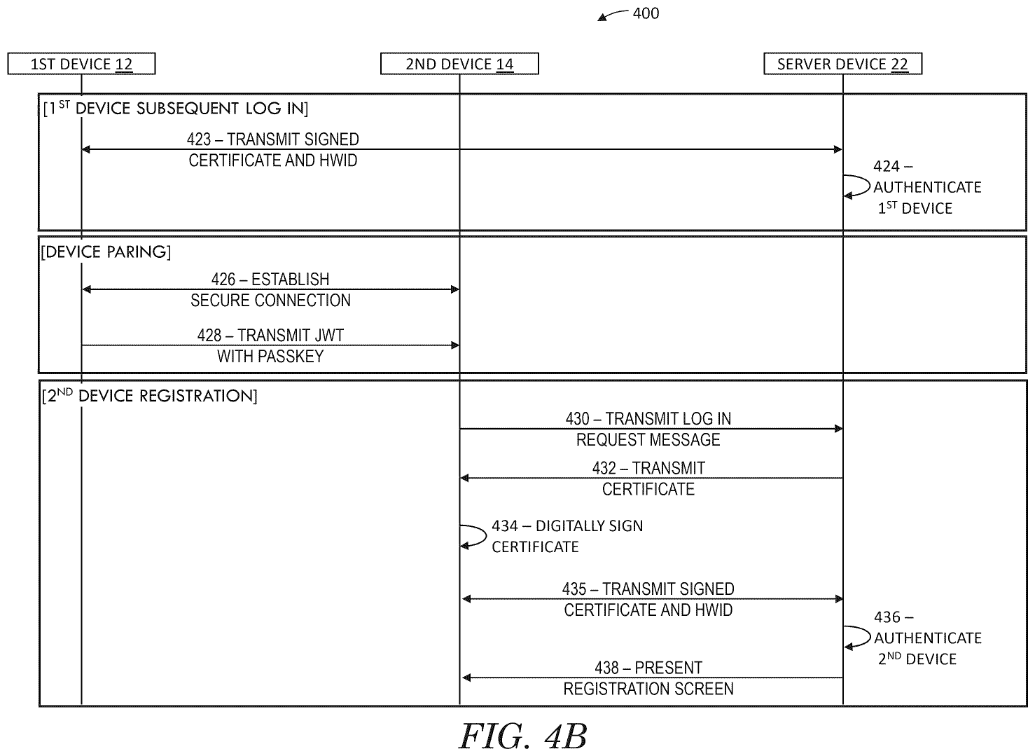

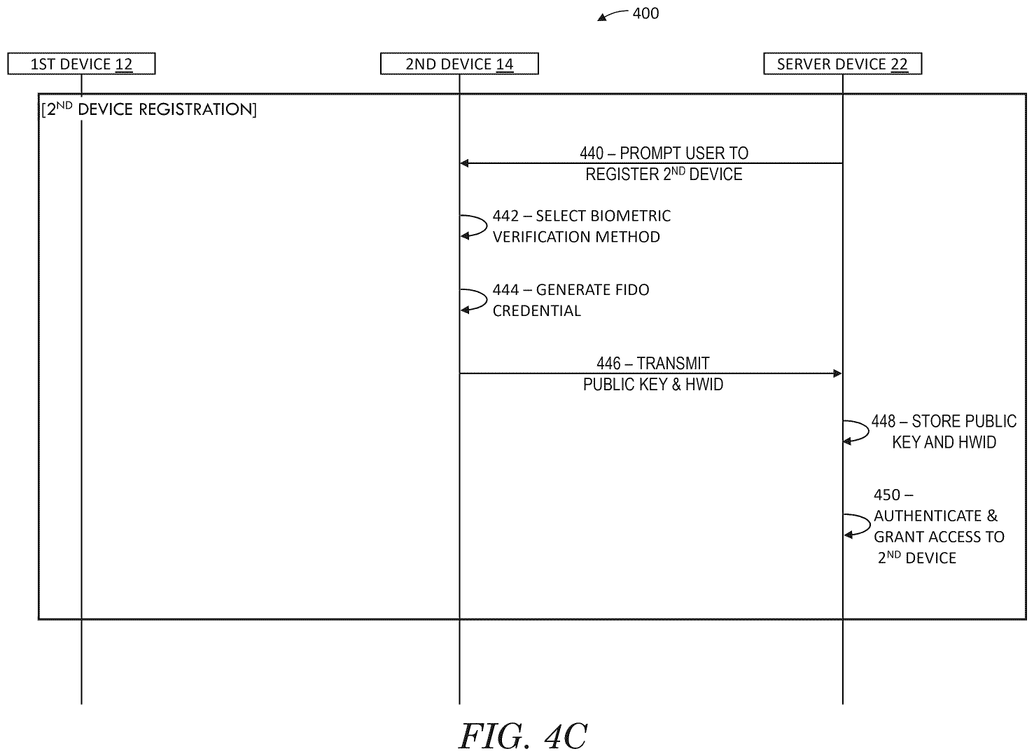

FIGS. 4A, 4B, and 4C depict a flowchart illustrating an exemplary computer-implemented method 400 for reducing account sharing via shared login credentials (e.g., userID and password), in accordance with embodiments of the present disclosure. The operations described herein may be performed in the order shown in FIGS. 4A, 4B, and 4C or may be performed in a different order. Furthermore, some operations may be performed concurrently as opposed to sequentially. In addition, some operations may be optional.

The computer-implemented method 400 is described below, for ease of reference, as being executed by exemplary devices and components introduced with the embodiments illustrated in FIGS. 1-3. In one embodiment, the method 400 may be implemented by the system 10 (shown in FIG. 1). In the exemplary embodiment, the method 400 generally concerns device registration via a passkey for an account or service provided by the service provider 20 and sharing of that passkey between devices for additional device registration. While operations within the method 400 are described below regarding the user computing devices 12, 14 and the server computing device 22, the method 400 may be implemented on other computing devices and/or systems through the utilization of processors, transceivers, hardware, software, firmware, or combinations thereof. A person having ordinary skill will further appreciate that responsibility for all or some of the actions may be distributed differently among such devices or other computing devices without departing from the spirit of the present disclosure.

One or more computer-readable medium(s) may also be provided. The computer-readable medium(s) may include one or more executable programs stored thereon, wherein the program(s) instruct one or more processors or processing units to perform all or certain of the operations outlined herein. The program(s) stored on the computer-readable medium(s) may instruct the processor or processing units to perform additional, fewer, or alternative actions, including those discussed elsewhere herein.

In the example embodiment, at operation 402, a user, such as the user 16 (shown in FIG. 1), may establish a communication link between his or her primary computing device 12 (shown in FIG. 1) and the server computing device 22 (shown in FIG. 1) of the service provider 20 (shown in FIG. 1). The communication link may be established via the network 18 (shown in FIG. 1) as described herein.

At operation 404, the user 16 (shown in FIG. 1) may attempt to log in to his or her account provided by the service provider 20, for example, by transmitting a log in request message to the server computing device 22. More particularly, the user 16 may attempt to log in to his or her account on his or her primary device 12 using his or her login credentials, such as a traditional username/password credential. The primary device 12 may be equipped with a user interface (UI) for the user 16 to enter his or her credentials, which are then transmitted to the server computing device 22 for verification, for example, by the authentication decision module 26 (shown in FIG. 1). The authentication decision module 26 may compare the entered credentials with stored account information, such as the user account records stored on the database 28 (shown in FIG. 1), to identify the account and its access controls or requirements. If an account record is identified, the authentication decision module 26 may determine whether a passkey is required. For example, if the account record includes a passkey stored in association with the account record, the passkey is required. Otherwise, a passkey is not required for an initial log in attempt. If a passkey is not required, the authentication decision module 26 may to determine the validity of the entered credentials by comparing them to the stored account credentials. If the authentication decision module 26 determines that the credentials match, the user 16 (or more particularly, the primary user device 12) may be authenticated and granted access to his or her account. Alternatively, if the credentials do not match, the authentication decision module 26 may not authenticate the primary device 12 and may deny further access to the server computing device 22 and/or terminate the communication link between the server computing device 22 and the primary device 12. If a passkey is required, the authentication decision module 26 may prompt the user 16 for the passkey, as described further below.

At operation 406, upon successfully authenticating and granting access to the user's account, the primary device 12 may be presented with or directed to a registration screen (i.e., a landing screen) for registering the primary device 12 with the account. The registration screen may serve as a main interface for registering devices and accessing various account features and services. The server computing device 22 may initialize a user session, for example, by creating a session token that may be used to authenticate subsequent requests without requiring the user 16 to re-enter his or her credentials. The registration screen may provide a seamless transition from login to account registration features.

At operation 408, the user 16 may receive a prompt on the registration screen to register his or her primary device 12 using a device-supported biometrics verification method. The prompt may be configured to encourage the user 16 to adopt a more secure and convenient authentication method for future log in attempts. By registering using a biometric verification method, the user 16 can later authenticate without needing to enter his or her credentials.

At operation 410, the user 16 may opt to register a device-supported biometrics verification method. For example, the primary device 12 of the user 16 may include one or more biometric capabilities (e.g., voice recognition, fingerprints, iris features, vein patterns, facial features, PIN entry, or the like) and may present the options to the user 16. The user 16 may select one or more of the biometrics verification method options for registration.

Upon selection of a biometrics verification method, at operation 412, the secure enclave, such as the secure enclave 36 (shown in FIG. 1) of the primary device 12 may generate a FIDO credential (also referred to herein as a “passkey”). The passkey may include a public-private key pair, where the private key is securely stored within the secure enclave 36, which is a dedicated hardware module designed to protect sensitive data. The public key, which is not sensitive, may be shared and used to verify signatures created by the private key, for example, during an authentication process. This operation may ensure that subsequent log in attempts can be performed securely and conveniently using biometrics of the user 16.

At operation 414, during the biometrics registration process, the public key may be transmitted to the server computing device 22. The server computing device 22 may store the public key in association with the user account at operation 416. For example, the server computing device 22 may store the public key in an account record of the user account on the database 28. Additionally, during the biometrics registration process, a device fingerprint or hardware identifier (HWID), which uniquely identifies the primary device 12, may be transmitted by the primary device 12 to the server computing device 22. The server computing device 22 may store the HWID in association with the user account. In an embodiment, the primary device 12 may tokenize the HWID to facilitate protecting its privacy. This setup may allow the server computing device 22 to recognize and trust the primary device 12 in future authentication attempts, as discussed below.

At operation 418, at a later time, the user 16 may attempt to log in to his or her account on his or her registered primary device 12. For example, when the user 16 requests to log in to the account on the server computing device 22, the primary device 12 may transmit an authentication request message to the server computing device 22, including its HWID or tokenized HWID. In response, the server computing device 22 may prompt the user 16 for the passkey. For example, the server computing device 22 may transmit a certificate or challenge to the primary device 12 at operation 420 in response to the request message. At operation 422, the primary device 12 may digitally sign the certificate or challenge using the passkey (i.e., the private key of the public-private key pair) and include the HWID or tokenized HWID in a response transmitted back to the server computing device 22 at operation 423. At operation 424, the server computing device 22, via the authentication decision module 26, may authenticate the primary device 12 by retrieving the passkey (i.e., the public key) and HWID associated with the user account, verifying the digital signature using the retrieved public key, and matching the HWID or tokenized HWID to the stored HWID. Upon verifying the digital signature and matching the HWIDs, the server computing device 22 may grant access to the account to the primary device 12. Using the passkey is advantageous because even if a fraudster or attacker obtains a signed certificate or the public key the fraudster/attacker cannot recalculate the private key. Additionally, the certificate or challenge also may be signed by the server computing device 22, allowing the primary device 12 to verify the certificate/challenge to ensure the certificate/challenge is received from the correct server computing device.

Later, the user 16 (or another user) may wish to add a secondary device and/or or attempt to log in to his or her account on a secondary device, such as the secondary device 14 (shown in FIG. 1). The secondary device 14, however, may not have the necessary credentials and/or passkey required to access the account. In an embodiment, the server computing device 22 may prompt the user 16, via the secondary device 14, to establish a connection with a registered device, such as the primary device 12, to receive credentials and/or a passkey required to access the account, as the primary device 12 holds the necessary authentication credentials.

At operation 426, the user 16 may initiate a pairing process between the primary device 12 and the secondary device 14 (i.e., pairing the two devices) to establish a secure communication channel. For example, and without limitation, the primary and secondary device 12 and 14 may be paired using a Wi-Fi network or a Bluetooth connection. This ensures that the data exchanged between the primary and secondary devices 12, 14 is protected from eavesdropping and/or tampering. During the pairing process, the primary and secondary devices 12, 14 may discover each other over a common network (e.g., Wi-Fi, Bluetooth, etc.). The devices perform the pairing process, which may include exchanging cryptographic keys to establish the secure communication channel. This process may involve protocols such as Bluetooth Secure Simple Pairing or Wi-Fi Protected Access (WPA). The primary device 12 may receive information from the secondary device 14, such as a device ID, network ID, and details of the Wi-Fi network, if used. This information may facilitate establishing the secure communication channel between the two devices 12, 14, ensuring that the credentials can be exchanged safely and securely.

At operation 428, after the secure connection is established between the primary device 12 and the secondary device 14, a copy of the credentials (i.e., the passkey) from the primary device 12 may be securely transferred to the secondary device 14. The transfer may be facilitated using a JSON Web Token (JWT), i.e., a compact and self-contained way to transmit information between devices securely. The JWT may contain the credentials (or passkey) and may be transmitted over the same Wi-Fi or Bluetooth secure communication channel. For example, the primary device 12, which already has the authentication credentials, may generate the JWT. The JWT may contain the credentials needed by the secondary device 14 to authenticate with the server computing device 22. The JWT may include a header specifying the signing algorithm (e.g., HS256, RS256, etc.). Additionally, the JWT may include a payload including the necessary claims, such as the authentication credential (e.g., the passkey). The primary device 12 may then sign the JWT using a secret key (for HMAC) or a private key (for RSA). The primary device 12 may then transmit the JWT securely to the secondary device 14 over the established secure communication channel. The secondary device 14, upon receipt of the JWT from the primary device 12, may validate the JWT using the shared secret or public key and extract the authentication credentials (e.g., the passkey) from the payload. The secondary device 14 may store the authentication credentials or passkey in its secure element or a protected storage area, such as the secure enclave 38 (shown in FIG. 1), ensuring they are protected from unauthorized access.

At operation 430, the user, such as the user 16, may log in to the account using the authentication credentials or passkey received from the primary device 12. For example, the user 16 may establish a communication link between the secondary computing device 14 and the server computing device 22 of the service provider 20. The communication link may be established via the network 18 as described herein. The secondary device may transmit an authentication request message to the server computing device 22, including a HWID of the secondary device 14. In response to the authentication request message, the server computing device 22 may transmit a certificate or challenge to the secondary device 14 at operation 432. At operation 434, the secondary device 12 may digitally sign the certificate or challenge using the received passkey and include the HWID in a response transmitted back to the server computing device 22 at operation 435. At operation 436, the server computing device 22, via the authentication decision module 26, may authenticate the secondary device 14 by verifying the digital signature using the public key associated with the account. However, the authentication decision module 26 may compare the received HWID to the HWID(s) associated with the account and determine that the received HWID does not match any HWID associated with the account.

At operation 438, in response to determining that the HWID received from the secondary device 14 does not match, but that the digital signature is valid, the server computing device 22 may present or direct the secondary device 14 to a registration screen to register the secondary device 14 with the account. The server computing device 22 may initialize a user session, for example, by creating a session token that may be used to authenticate subsequent requests without requiring the user 16 to re-enter his or her credentials.

At operation 440, the user 16 may receive a prompt on the registration screen to register his or her secondary device 14 using a device-supported biometrics verification method. The prompt may be configured to encourage the user 16 to adopt a more secure and convenient authentication method for future log in attempts. By registering using a biometric verification method, the user 16 can later authenticate without needing to enter his or her credentials.

At operation 442, the user 16 may opt to register a device-supported biometrics verification method. For example, the secondary device 14 of the user 16 may include one or more biometric capabilities (e.g., voice recognition, fingerprints, iris features, vein patterns, facial features, PIN entry, or the like) and may present the options to the user 16. The user 16 may select one or more of the biometrics verification method options for registration.

Upon selection of a biometrics verification method, at operation 444, the secure enclave, such as the secure enclave 38 of the secondary device 14 may generate a second FIDO credential (also referred to herein as a “second passkey”). The second passkey may include a second public-private key pair, where the second private key is securely stored within the secure enclave 38. The second public key, which is not sensitive, may be shared and used to verify signatures created by the second private key, for example, during an authentication process. This operation may ensure that subsequent log in attempts can be performed securely and conveniently using biometrics of the user 16 at the secondary device 14.

At operation 446, during the biometrics registration process, the second public key may be transmitted to the server computing device 22. The server computing device 22 may store the second public key in association with the user account at operation 448. For example, the server computing device 22 may store the second public key in the account record of the user account on the database 28. Additionally, during the biometrics registration process, a second device fingerprint or hardware identifier (HWID), which uniquely identifies the secondary device 14, may be transmitted by the secondary device 14 to the server computing device 22 and stored in association with the user account. In an embodiment, the secondary device 14 may tokenize the HWID to facilitate protecting its privacy. This setup may allow the server computing device 22 to recognize and trust the secondary device 14 in future authentication attempts. At operation 450, after registration of the secondary device 14, the server computing device 22 authenticates and grants access to the account. In some embodiments, the passkey associated with the primary device 12 may be the only passkey allowed to be used to log in and associate additional devices with the account. This may facilitate reducing or eliminating passkey sharing between multiple individuals.

### Additional Considerations

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

The detailed description is to be construed as exemplary only and does not describe every possible embodiment because describing every possible embodiment would be impractical. Numerous alternative embodiments may be implemented, using either current technology or technology developed after the filing date of this application, which would still fall within the scope of the invention.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order recited or illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. The foregoing statements in this paragraph shall apply unless so stated in the description and/or except as will be readily apparent to those skilled in the art from the description.

As used herein, the term “database” includes either a body of data, a relational database management system (RDBMS), or both. As used herein, a database includes, for example, and without limitation, a collection of data including hierarchical databases, relational databases, flat file databases, object-relational databases, object-oriented databases, and any other structured collection of records or data that is stored in a computer system. Examples of RDBMS's include, for example, and without limitation, Oracle® Database (Oracle is a registered trademark of Oracle Corporation, Redwood Shores, Calif.), MySQL, IBM® DB2 (IBM is a registered trademark of International Business Machines Corporation, Armonk, N. Y.), Microsoft® SQL Server (Microsoft is a registered trademark of Microsoft Corporation, Redmond, Wash.), Sybase® (Sybase is a registered trademark of Sybase, Dublin, Calif.), and PostgreSQL® (PostgreSQL is a registered trademark of PostgreSQL Community Association of Canada, Toronto, Canada). However, any database may be used that enables the systems and methods to operate as described herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processor, may be implemented as special purpose or as general purpose. For example, the processor may comprise dedicated circuitry or logic that is permanently configured, such as an application-specific integrated circuit (ASIC), or indefinitely configured, such as a field-programmable gate array (FPGA), to perform certain operations. The processor may also comprise programmable logic or circuitry (e.g., as encompassed within a general-purpose processor or other programmable processor) that is temporarily configured by software to perform certain operations. It will be appreciated that the decision to implement the processor as special purpose, in dedicated and permanently configured circuitry, or as general purpose (e.g., configured by software) may be driven by cost and time considerations.

Accordingly, the term “processor” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processor is temporarily configured (e.g., programmed), each of the processors need not be configured or instantiated at any one instance in time. For example, where the processor comprises a general-purpose processor configured using software, the general-purpose processor may be configured as respective different processors at different times. Software may accordingly configure the processor to constitute a particular hardware configuration at one instance of time and to constitute a different hardware configuration at a different instance of time.

Computer hardware components, such as transceiver elements, memory elements, processors, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processors may be located in a single location (e.g., within a home environment, an office environment or as a server farm), while in other embodiments the processors may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processor and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Although the disclosure has been described with reference to the embodiments illustrated in the attached figures, it is noted that equivalents may be employed, and substitutions made herein, without departing from the scope of the disclosure as recited in the claims.

Having thus described various embodiments of the disclosure, what is claimed as new and desired to be protected by Letters Patent includes the following:

What is claimed is:

1. A computing system comprising:
a database storing a user account record associated with a user account of a user, the user account record including stored authentication credentials having a first username and a first password;
one or more processors; and
computer-executable instructions, that when executed by the one or more processors, cause the one or more processors to perform the operations of:
receiving, from a primary computing device associated with the user, a log in request message to log in to the user account, the log in request message including received authentication credentials, the received authentication credentials including a second username and a second password;
comparing the received authentication credentials to the stored authentication credentials;
determining that the received authentication credentials match the stored authentication credentials;
based on the match determination, prompting the user to register the primary computing device using a device-supported biometrics verification method of the primary computing device;
receiving, from the primary computing device, a passkey and a hardware identifier (HWID) associated with the primary computing device;
storing the passkey and HWID in the database in association with the user account record;
receiving a second log in request message to log in to the user account from a secondary computing device;
in response to the second log in request message, transmitting a certificate to the secondary computing device;
receiving, from the secondary computing device, a second HWID associated with the secondary computing device and the certificate, digitally signed using the passkey associated with the primary computing device and transmitted to the secondary computing device;
verifying a digital signature of the digitally signed certificate utilizing the passkey stored in association with the account;
comparing the second HWID to the stored HWID in the database;
determining that the second HWID does not match the stored HWID;
in response to verifying the digital signature and determining that the second HWID does not match, prompting a second user of the secondary computing device to register the secondary computing device using a device-supported biometrics verification method of the secondary computing device;
receiving, from the secondary computing device, a second passkey and the second HWID; and
storing the second passkey and second HWID in the database in association with the user account record.

2. The computing system in accordance with claim 1,
the computer-executable instructions, that when executed by the one or more processors, cause the one or more processors to perform the operation of establishing a communication link to the primary computing device via a communications network.

3. The computing system in accordance with claim 1,
the computer-executable instructions, that when executed by the one or more processors, cause the one or more processors to perform the operation of granting the primary computing device access to the account based on the match determination.

4. The computing system in accordance with claim 1,
the computer-executable instructions, that when executed by the one or more processors, cause the one or more processors to perform the operation of presenting a registration screen to the primary computing device for device registration.

5. The computing system in accordance with claim 1,
the computer-executable instructions, that when executed by the one or more processors, cause the one or more processors to perform the operation of presenting a registration screen to the secondary computing device for device registration.

6. The computing system in accordance with claim 1,
the computer-executable instructions, that when executed by the one or more processors, cause the one or more processors to perform the operation of determining that a passkey is required to log in to the user account.

7. The computing system in accordance with claim 6,
the computer-executable instructions, that when executed by the one or more processors, cause the one or more processors to perform the operations of:
receiving, from the primary computing device, a third log in request message to log in to the user account;
in response, transmitting a certificate to the primary computing device;
receiving, from the primary computing device, the HWID associated with the primary computing device and the certificate, digitally signed using the passkey;
verifying a digital signature of the digitally signed certificate utilizing the passkey associated with the account;
comparing the HWID to the stored HWID in the database;
determining that the HWID matches the stored HWID; and
in response to verifying the digital signature and determining that the HWID matches the stored HWID, granting the primary computing device access to the user account.

8. A method performed by a computing system, the computing system including a database storing a user account record associated with a user account of a user, the user account record including stored authentication credentials having a first username and a first password, the method comprising:
receiving, from a primary computing device associated with the user, a log in request message to log in to the user account, the log in request message including received authentication credentials, the received authentication credentials including a second username and a second password;
comparing the received authentication credentials to the stored authentication credentials;
determining that the received authentication credentials match the stored authentication credentials;
based on the match determination, prompting the user to register the primary computing device using a device-supported biometrics verification method of the primary computing device;
receiving, from the primary computing device, a passkey and a hardware identifier (HWID) associated with the primary computing device;
storing the passkey and HWID in the database in association with the user account record;
receiving a second log in request message to log in to the user account from a secondary computing device;
in response to the second log in request message, transmitting a certificate to the secondary computing device;
receiving, from the secondary computing device, a second HWID associated with the secondary computing device and the certificate, digitally signed using the passkey associated with the primary computing device and transmitted to the secondary computing device;
verifying a digital signature of the digitally signed certificate utilizing the passkey associated with the account;
comparing the second HWID to the stored HWID in the database;
determining that the second HWID does not match the stored HWID;
in response to verifying the digital signature and determining that the second HWID does not match, prompting a second user of the secondary computing device to register the secondary computing device using a device-supported biometrics verification method of the secondary computing device;
receiving, from the secondary computing device, a second passkey and the second HWID; and
storing the second passkey and second HWID in the database in association with the user account record.

9. The method in accordance with claim 8, further comprising establishing a communication link to the primary computing device via a communications network.

10. The method in accordance with claim 8, further comprising granting the primary computing device access to the account based on the match determination.

11. £ The method in accordance with claim 8, further comprising presenting a registration screen to the primary computing device for device registration.

12. The method in accordance with claim 8, further comprising presenting a registration screen to the secondary computing device for device registration.

13. The method in accordance with claim 8, further comprising determining that a passkey is required to log in to the user account.

14. The method in accordance with claim 13, further comprising:
receiving, from the primary computing device, a third log in request message to log in to the user account;
in response, transmitting a certificate to the primary computing device;
receiving, from the primary computing device, the HWID associated with the primary computing device and the certificate, digitally signed using the passkey;
verifying a digital signature of the digitally signed certificate utilizing the passkey associated with the account;
comparing the HWID to the stored HWID in the database;
determining that the HWID matches the stored HWID; and
in response to verifying the digital signature and determining that the HWID matches the stored HWID, granting the primary computing device access to the user account.

15. A non-transitory computer-readable storage medium having computer-executable instructions stored thereon, the computer-executable instructions, when executed by one or more processors, causing the one or more processors to perform operations of:
receiving, from a primary computing device associated with a user, a log in request message to log in to a user account, the log in request message including received authentication credentials, the received authentication credentials including a first username and a first password;
comparing the received authentication credentials to stored authentication credentials stored in a database, the database storing a user account record associated with the user account of the user, the user account record including the stored authentication credentials having a second username and a second password;
determining that the received authentication credentials match the stored authentication credentials;
based on the match determination, prompting the user to register the primary computing device using a device-supported biometrics verification method of the primary computing device;
receiving, from the primary computing device, a passkey and a hardware identifier (HWID) associated with the primary computing device;
storing the passkey and HWID in the database in association with the user account record;
receiving a second log in request message to log in to the user account from a secondary computing device;
in response to the second log in request message, transmitting a certificate to the secondary computing device;
receiving, from the secondary computing device, a second HWID associated with the secondary computing device and the certificate, digitally signed using the passkey associated with the primary computing device and transmitted to the secondary computing device;
verifying a digital signature of the digitally signed certificate utilizing the passkey associated with the account;
comparing the second HWID to the stored HWID in the database;
determining that the second HWID does not match the stored HWID;
in response to verifying the digital signature and determining that the second HWID does not match, prompting a second user of the secondary computing device to register the secondary computing device using a device-supported biometrics verification method of the secondary computing device;
receiving, from the secondary computing device, a second passkey and the second HWID; and
storing the second passkey and second HWID in the database in association with the user account record.

16. The non-transitory computer-readable storage medium in accordance with claim 15,
the computer-executable instructions causing the one or more processors to perform the operation of establishing a communication link to the primary computing device via a communications network.

17. The non-transitory computer-readable storage medium in accordance with claim 15,
the computer-executable instructions causing the one or more processors to perform the operation of granting the primary computing device access to the account based on the match determination.

18. The non-transitory computer-readable storage medium in accordance with claim 15,
the computer-executable instructions causing the one or more processors to perform the operation of presenting a registration screen to the primary computing device for device registration.

19. The non-transitory computer-readable storage medium in accordance with claim 15,
the computer-executable instructions causing the one or more processors to perform the operation of presenting a registration screen to the secondary computing device for device registration.

20. The non-transitory computer-readable storage medium in accordance with claim 15,
the computer-executable instructions causing the one or more processors to perform the operations of:
receiving, from the primary computing device, a third log in request message to log in to the user account;
determining that a passkey is required to log in to the user account;
transmitting a certificate to the primary computing device;
receiving, from the primary computing device, the HWID associated with the primary computing device and the certificate, digitally signed using the passkey;
verifying a digital signature of the digitally signed certificate utilizing the passkey associated with the account;
comparing the HWID to the stored HWID in the database;
determining that the HWID matches the stored HWID; and
in response to verifying the digital signature and determining that the HWID matches the stored HWID, granting the primary computing device access to the user account.
